(19) United States
(12) Patent Application Publication
(10) Pub. No.: US 2004/0171753 A1
(43) Pub. Date: Sep. 2, 2004

(54) Polymeric blends that adhere to polycarbonates and polycarbonate alloys

(76) Inventors: Purushottam Das Agrawal, Akron, OH (US); Marvin C. Hill, Hudson, OH (US); Kelly Kirkendall, Akron, OH (US)

Correspondence Address: MANDI MILBANK, EXXONMOBIL LAW TECHNOLOGY, PO BOX 2149, BAYTOWN, TX, 77520-2149, US

(21) Appl. No.: 10/749,781

(22) Filed: Dec. 30, 2003

Related U.S. Application Data
(60) Provisional application No. 60/438,407, filed on Jan. 7, 2003.

(51) Int. Cl. C08L 23/00; C08L 25/00; C08L 47/00; C08G 18/00; C08L 75/00

(52) U.S. Cl. 525/123; 525/130

(57) ABSTRACT

The invention relates to polymeric blends comprising at least about 40 percent by weight thermoplastic polyurethane elastomer; and from about 10 to about 250 parts by weight ethylene vinyl acetate copolymer per 100 parts by weight thermoplastic polyurethane elastomer. These blends exhibit high adhesion to polycarbonates and polycarbonate alloys.

### FIELD OF THE INVENTION

The present invention relates to polymeric blends that have high adhesion to polycarbonates and polycarbonate alloys.

### BACKGROUND OF THE INVENTION

Thermoplastic polyurethane elastomers (TPUs) are known polymers that have a variety of uses. These materials have many of the characteristics of elastomers but are thermally processable as thermoplastics. One shortcoming of TPUs is their poor adhesion to polyesters. Another shortcoming is that their heat stability is rather low. That is, most TPUs melt at a temperature of about 170° C. When coupled with the fact that TPUs are fairly hygroscopic, the ability to use TPUs is severely limited. For example, TPUs are not useful in environments where they undergo prolonged exposure to steam.

In one particular use, TPUs are employed to make seals for microwavable containers that are made from polycarbonate or polycarbonate/polyethyleneteraphthalate alloys. Adhesion to these containers is limited by the presence of the polyethyleneteraphthalate, which is a polyester, and the durability of these seals is limited by the fact that the seals will distort when subjected to extremely hot water or steam, which is commonly experienced in microwaves or dishwashers.

### SUMMARY OF THE INVENTION

In general the present invention provides a polymeric blend comprising at least about 40 percent by weight thermoplastic polyurethane elastomer, and from about 10 to about 250 parts by weight ethylene vinyl acetate copolymer per 100 parts by weight thermoplastic polyurethane elastomer.

The present invention also includes a polymeric blend comprising at least about 40 percent by weight thermoplastic polyurethane elastomer, from about 10 to about 250 parts by weight ethylene vinyl acetate copolymer per 100 parts by weight thermoplastic polyurethane elastomer, and from about 10 to about 60 parts by weight polypropylene per 100 parts by weight thermoplastic polyurethane elastomer.

The present invention further includes a polymeric blend comprising from about 48 to about 52 percent by weight thermoplastic polyurethane elastomer, from about 18 to about 22 percent by weight ethylene vinyl acetate copolymer, from about 13 to about 17 percent by weight thermoplastic vulcanizate comprising a blend of polypropylene and EPDM, from about 8 to about 12 percent polypropylene homopolymer, and from about 3 to about 7 percent maleated polypropylene.

The present invention still further includes a polymeric blend comprising, from about 58 to about 62 percent by weight thermoplastic polyurethane elastomer, from about 13 to about 17 percent by weight ethylene vinyl acetate copolymer, from about 13 to about 17 percent by weight thermoplastic vulcanizate comprising a blend of polypropylene and EPDM, from about 3 to about 7 percent polypropylene homopolymer, and from about 3 to about 7 percent maleated polypropylene.

It has now been found that the adhesion of thermoplastic polyurethane elastomers to polyesters can be improved by creating blends of TPUs and ethylene vinyl acetate copolymers (EVAs). Surprisingly, the overall adhesive properties of these blends, in certain embodiments, has been found to be greater than the adhesive properties of either the TPU or EVAs alone. Furthermore, it has surprisingly been found that the overall physical and mechanical properties of the polymeric blends remains technologically useful as compared to the physical and mechanical properties of TPUs or EVAs alone. It is believed that the TPUs and the EVAs have a synergistic effect.

It has also been found that the poor heat stability and hygroscopic nature of the TPUs can be improved by preparing blends of TPUs, EVAs, and non-polar polymers having a high melt temperature. The modulus of these polymeric blends is also advantageously high.

### DETAILED DESCRIPTION OF ILLUSTRATIVE EMBODIMENTS

I. General

The polymeric blends of this invention include a thermoplastic polyurethane elastomer and a ethylene vinyl acetate copolymer. In one embodiment, the polymeric blends include a TPU, an EVA, and a non-polar polymer having a high melt temperature. Other ingredients may likewise be included such as compatibilizing agents, softening agents, or other additives typically employed in polymeric compositions.

II. Thermoplastic Polyurethane

The TPU component has no limitation in respect of its formulation other than the requirement that it be thermoplastic in nature which means it is prepared from substantially difunctional ingredients, i.e., organic diisocyanates and components being substantially difunctional in active hydrogen containing groups. However, often times minor proportions of ingredients with functionalities higher than two may be employed. This is particularly true when using extenders such as glycerin, trimethylolpropane, and the like. Accordingly, any of the TPU materials known in the art can be employed in the present blends. For representative teaching on the preparation of TPU materials see Polyurethanes: Chemistry and Technology, Part II, Saunders and Frisch, 1964, pp 767 to 769, Interscience Publishers, New York, N.Y. and Polyurethane Handbook, Edited by G. Oertel 1985, pp 405 to 417, Hanser Publications, distributed in U.S.A. by Macmillan Publishing Co., Inc., New York, N.Y. For particular teaching on various TPU materials and their preparation see U.S. patent publications U.S. Pat. Nos. 2,929,800; 2,948,691; 3,493,634; 3,620,905; 3,642,964; 3,963,679; 4,131,604; 4,169,196; Re 31,671; 4,245,081; 4,371,684; 4,379,904; 4,447,590; 4,523,005; 4,621,113; 4,631,329; and 4,883,837, which are incorporated herein by reference. Similar definitions can be found in U.S. Pat. Nos. 6,001,484, 5,852,118, and 6,072,003, which are incorporated herein by reference.

The preferred TPU is a polymer prepared from a mixture comprising at least one organic diisocyanate, at least one polymeric diol and at least one difunctional extender. The TPU may be prepared by the prepolymer, quasi-prepolymer, or one-shot methods in accordance with the methods described in the references above.

Any of the organic diisocyanates previously employed in TPU preparation can be employed including blocked or unblocked aromatic, aliphatic, and cycloaliphatic diisocyanates, and mixtures thereof.

Illustrative isocyanates but non-limiting thereof are methylenebis(phenyl isocyanate) including the 4,4′-isomer, the 2,4′-isomer and mixtures thereof, m- and p-phenylene diisocyanates, chlorophenylene diisocyanates, α,α′-xylylene diisocyanate, 2,4- and 2,6-toluene diisocyanate and the mixtures of these latter two isomers which are available commercially, tolidine diisocyanate, hexamethylene diisocyanate, 1,5-naphthalene diisocyanate, isophorone diisocyanate and the like; cycloaliphatic diisocyanates such as methylenebis(cyclohexyl isocyanate) including the 4,4′-isomer, the 2,4′-isomer and mixtures thereof, and all the geometric isomers thereof including trans/trans, cis/trans, cis/cis and mixtures thereof, cyclohexylene diisocyanates (1,2-; 1,3-; or 1,4-), 1-methyl-2,5-cyclohexylene diisocyanate, 1-methyl-2,4-cyclohexylene diisocyanate, 1-methyl-2,6-cyclohexylene diisocyanate, 4,4′-isopropylidenebis(cyclohexyl isocyanate), 4,4′-diisocyanatodicyclohexyl, and all geometric isomers and mixtures thereof and the like. Also included are the modified forms of methylenebis(phenyl isocyanate). By the latter are meant those forms of methylenebis(phenyl isocyanate) which have been treated to render them stable liquids at ambient temperature (about 20° C.). Such products include those which have been reacted with a minor amount (up to about 0.2 equivalents per equivalent of polyisocyanate) of an aliphatic glycol or a mixture of aliphatic glycols such as the modified methylenebis(phenyl isocyanates) described in U.S. Pat. Nos. 3,394,164; 3,644,457; 3,883,571; 4,031;026; 4,115,429; 4,118,411; and 4,299,347, which are incorporated herein by reference. The modified methylenebis(phenyl isocyanates) also include those which have been treated so as to convert a minor proportion of the diisocyanate to the corresponding carbodiimide which then interacts with further diisocyanate to form uretone-imine groups, the resulting product being a stable liquid at ambient temperatures as described, for example, in U.S. Pat. No. 3,384,653. Mixtures of any of the above-named polyisocyanates can be employed if desired.

Preferred classes of organic diisocyanates include the aromatic and cycloaliphatic diisocyanates. Preferred species within these classes are methylenebis(phenyl isocyanate) including the 4,4′-isomer, the 2,4′-isomer, and mixtures thereof, and methylenebis (cyclohexyl isocyanate) inclusive of the isomers described above.

The polymeric diols which can be used are those conventionally employed in the art for the preparation of TPU elastomers. The polymeric diols are responsible for the formation of soft segments in the resulting polymer and advantageously have molecular weights (number average) falling in the range of 400 to 4,000 and preferably 500 to 3,000. It is not unusual, and, in some cases, it can be advantageous to employ more than one polymeric diol. Exemplary of the diols are polyether diols, polyester diols, hydroxy-terminated polycarbonates, hydroxy-terminated polybutadienes, hydroxy-terminated polybutadiene-acrylonitrile copolymers, hydroxy-terminated copolymers of dialkyl siloxane and alkylene oxides such as ethylene oxide, propylene oxide and the like, and mixtures in which any of the above polyols are employed as major component (greater than 50% w/w) with amino-terminated polyethers and amino-terminated polybutadiene-acrylonitrile copolymers.

Illustrative of polyether polyols are polyoxyethylene glycols, polyoxypropylene glycols which, optionally, have been capped with ethylene oxide residues, random and block copolymers of ethylene oxide and propylene oxide; polytetramethylene glycol, random and block copolymers of tetrahydrofuran and ethylene oxide and/or propylene oxide, and products derived from any of the above reaction with di-functional carboxylic acids or ester derived from said acids in which latter case ester interchange occurs and the esterifying radicals are replaced by polyether glycol radicals. The preferred polyether polyols are random and block copolymers of ethylene and propylene oxide of functionality approximately 2.0 and polytetramethylene glycol polymers of functionality about 2.0.

Illustrative of polyester polyols are those prepared by polymerizing ε-caprolactone using an initiator such as ethylene glycol, ethanolamine, and the like; and those prepared by esterification of polycarboxylic acids such as phthalic, terephthalic, succinic, glutaric, adipic, azelaic, and the like; acids with polyhydric alcohols such as ethylene glycol, butanediol, cyclohexanedimethanol, and the like.

Illustrative of the amine-terminated polyethers are the aliphatic primary di-amines structurally derived from polyoxypropylene glycols. Polyether diamines of this type are available from Jefferson Chemical Company under the trademark JEFFAMINE™.

Illustrative of polycarbonates containing hydroxyl groups are those prepared by reaction of diols such as propane-1,3-diol, butane-1,4-diol, hexan-1,6-diol, 1,9-nonanediol, 2-methyloctane-1,8-diol, diethylene glycol, triethylene glycol, dipropylene glycol, and the like, with diarylcarbonates such as diphenylcarbonate or with phosgene.

Illustrative of the silicon-containing polyethers are the copolymers of alkylene oxides with dialkylsiloxanes such as dimethylsiloxane, and the like; see, for example, U.S. Pat. No. 4,057,595 or U.S. Pat. No. 4,631,329 cited supra.

Illustrative of the hydroxy-terminated polybutadiene copolymers are the compounds available under the tradename Poly BD Liquid Resins. Illustrative of the hydroxy- and amine-terminated butadiene/acrylonitrile copolymers are the materials available under the trade name HYCAR hydroxyl-terminated (HT) liquid polymers and amine-terminated (AT) liquid polymers, respectively. Preferred diols are the polyether and polyester diols set forth above.

The difunctional extender employed can be any of those known in the TPU art disclosed above. Typically the extenders can be aliphatic straight and branched chain diols having from 2 to 10 carbon atoms, inclusive, in the chain. Illustrative of such diols are ethylene glycol, 1,3-propanediol, 1,4-butanediol, 1,5-pentanediol, 1,6-hexanediol, neopentyl glycol, and the like; 1,4-cyclohexandimethanol; hydroquinonebis-(hydroxyethyl)ether, cyclohexylenediols (1,4-,1,3-, and 1,2-isomers), isopropylidenebis(cyclohexanols); diethylene glycol, dipropylene glycol, ethanolamine, N-methyl-diethanolamine, and the like; and mixtures of any of the above. As noted previously, in some cases minor proportions (less than about 20 equivalent percent) of the difunctional extender may be replaced by trifunctional extenders without detracting from the thermoplasticity of the resulting TPU; illustrative of such extenders are glycerol, trimethylolpropane, and the like.

While any of the diol extenders described and exemplified above can be employed alone, or in admixture, it is preferred to use 1,4-butanediol, 1,6-hexanediol, neopentyl glycol, 1,4-cyclohexanedimethanol, ethylene glycol, and diethylene glycol, either alone or in admixture with each other or with one or more aliphatic diols previously named. Particularly preferred diols are 1,4-butanediol, 1,6-hexanediol, and 1,4-cyclohexanedimethanol.

The equivalent proportions of polymeric diol to said extender can vary considerably depending on the desired hardness for the TPU product. Generally speaking, the proportions fall within the respective range of from about 1:1 to about 1:20, preferably from about 1:2 to about 1:10. At the same time the overall ratio of isocyanate equivalents to equivalents of active hydrogen containing materials is within the range of 0.90:1 to 1.10:1, and preferably, 0.95:1 to 1.05:1.

The TPU's can be prepared by conventional methods which are known to the artisan, for instance from U.S. Pat. No. 4,883,837 and the further references cited therein, which are incorporated herein by reference.

TPUs are commercially available. Particularly preferred TPUs include those available under the tradename PELLETHANE™, such as PELLETHANE™ 1000-85A (Dow; Midland, Mich.).

III. Ethylene Vinyl Acetate (EVA)

Conventional ethylene vinyl acetate copolymers may be employed in practicing the present invention.

A. Characteristics

The preferred ethylene vinyl acetate copolymers (EVAs) will include a vinyl acetate concentration of from about 6.5 to about 35 percent by weight, more preferably from about 15 to about 33 percent by weight, and even more preferably from about 25 to about 31 percent by weight.

B. Physical Properties

The preferred ethylene vinyl acetate copolymers have a density from about 0.940 to about 0.965 g/cm³, and more preferably from about 0.950 to about 0.960 g/cm³. Furthermore, the preferred ethylene vinyl acetate copolymers will have a melt flow index from about 20 to about 40 g/10 min., more preferably from about 25 to about 35 g/10 min, and still more preferably from about 27 to about 32 g/10 min, as per ASTM D-1238.

C. Mechanical Properties

The preferred ethylene vinyl acetate copolymers will have a Shore A hardness of from about 45 to about 80, and more preferably form about 55 to about 75.

D. Commercial Source

Useful ethylene vinyl acetate copolymers can be obtained under the tradenames LD 740, LD 755, LD 761, LD 767, LD 768, LD 782, LD 783, MV 02528, UL 7720, UL 7740, UL 7750, LD 7760, UL 7765, UL 7840C, and UL 8705 (ExxonMobil; Houston, Tex.)

IV. Non-polar High Melt Polymers

The non-polar polymers are characterized by having a high melt temperature and low hygroscopicity. Preferably, these non-polar polymers are crystallizable polyolefins. The preferred crystallizable polyolefins are formed by polymerizing ∀-olefins such as propylene, 1-butene, 1-hexene, 1-octene, 2-methyl-1-propene, 3-methyl-1-pentene, 4-methyl-1-pentene, 2-methyl-1-hexene, and mixtures thereof. Copolymers of ethylene and propylene or ethylene or propylene with another ∀-olefin such as 1-butene, 1-hexene, 1-octene, 2-methyl-1-propene, 3-methyl-1-pentene, 4-methyl-1-pentene, 5-methyl-1-hexene or mixtures thereof is also contemplated. These homopolymers and copolymers may be synthesized by using any polymerization technique known in the art such as, but not limited to, the “Phillips catalyzed reactions,” conventional Ziegler-Natta type polymerizations, and metallocene catalysis including, but not limited to, metallocene-alumoxane and metallocene-ionic activator catalysis.

These polymers are solid, generally high molecular weight plastic materials. Preferably, these resins are crystalline or a semi-crystalline polymers that preferably have a crystallinity of at least 25 percent as measured by differential scanning calorimetry.

These polyalphaolefins preferably have a weight average molecular weight (M_{w}) from about 200,000 to about 700,000, and a number average molecular weight (Mₙ) from about 80,000 to about 200,000. More preferably, these resins have a M_{w} from about 300,000 to about 600,000, and a Mₙ from about 90,000 to about 150,000.

The polyalphaolefins generally have a melt temperature (Tₘ) that is from about 150 to about 175 EC, preferably from about 155 to about 170 EC, and even more preferably from about 160 to about 170 EC. The glass transition temperature (Tg) of these resins is from about −5 to about 10 EC, preferably from about −3 to about 5 EC, and even more preferably from about 0 to about 2 EC. The crystallization temperature (T_{c}) of these resins is from about 95 to about 130 EC, preferably from about 100 to about 120 EC, and even more preferably from about 105 to about 115 EC as measured by DSC and cooled at 10 EC/min.

The polyalphaolefins generally have a melt flow rate that is less than about 10 dg/min, preferably less than about 2 dg/min, and still more preferably less than about 0.8 dg/min. Melt flow rate is a measure of how easily a polymer flows under standard pressure, and is measured by using ASTM D-1238 at 230 EC and 2.16 kg load.

An especially preferred thermoplastic resin is high-crystalline isotactic or syndiotactic polypropylene. This polypropylene generally has a density of from about 0.85 to about 0.91 g/cc, with the largely isotactic polypropylene having a density of from about 0.90 to about 0.91 g/cc. Also, high and ultra-high molecular weight polypropylene that has a fractional melt flow rate is highly preferred. These polypropylene resins are characterized by a melt flow rate that is less than or equal to 10 dg/min and more preferably less than or equal to 1.0 dg/min per ASTM D-1238.

V. Softening Agents

A. General

Various softening agents can be employed to soften the polymeric blends of this invention. Exemplary softening agents include elastomeric copolymers such as terpolymers of ethylene, α-olefins, and optionally diene monomers as described in U.S. Pat. Nos. 6,433,090 and 6,437,030, which are incorporated herein by reference, thermoplastic vulcanizates, and thermoplastic elastomer copolymers.

B. Thermoplastic Vulcanizate

Thermoplastic vulcanizates (TPVs) are thermoplastic elastomers that include polymeric blends of partially or fully cured ethylene-propylene-diene terpolymer dispersed within a polypropylene matrix. These thermoplastic vulcanizates are described in U.S. Pat. Nos. 4,130,534, 4,141,863, 4,427,049, 4,130,535, and 4,311,628, which are incorporated herein by reference. These thermoplastic vulcanizates are available under the tradename SANTOPRENE™ (Advanced Elastomer Systems; Akron, Ohio). The preferred SANTOPRENE™ is SANTOPRENE™ 101, 201, 211 171, or 271, which can be obtained with a Shore A of 55 to 73. These TPVs include about 12 to about 18 percent by weight polypropylene, based upon the entire weight of the TPV.

C. Thermoplastic Elastomer Copolymer

The thermoplastic elastomer copolymer is preferably a block copolymer that includes at least one rubbery block and at least one thermoplastic block. Preferably, the copolymer is a triblock that includes at least two thermoplastic blocks attached to opposite ends of a rubber block. The molecular structure of the copolymers may be straight-chain, branched-chained, radial, or types and combinations thereof.

These copolymers preferably have a number average molecular weight (Mn) of from about 100,000 to about 1,000,000, preferably from about 125,000 to about 800,000, and more preferably from about 150,000 to about 500,000. The molecular weight distribution ratio (M_{w}/Mₙ) is preferably 10 or less.

Useful thermoplastic elastomer copolymers include, but are not limited to, styrene/butadiene rubber (SBR), styrene/isoprene rubber (SIR), styrene/isoprene/butadiene rubber (SIBR), styrene-butadiene-styrene block copolymer (SBS), hydrogenated styrene-butadiene-styrene block copolymer (SEBS), hydrogenated styrene-butadiene block copolymer (SEB), styrene-isoprene-styrene block copolymer (SIS), styrene-isoprene block copolymer (SI), hydrogenated styrene-isoprene block copolymer (SEP), hydrogenated styrene-isoprene-styrene block copolymer (SEPS), styrene-ethylene/butylene-ethylene block copolymer (SEBE), styrene-ethylene-styrene block copolymer (SES), ethylene-ethylene/butylene block copolymer (EEB), ethylene-ethylene/butylene/styrene block copolymer (hydrogenated BR-SBR block copolymer), styrene-ethylene/butylene-ethylene block copolymer (SEBE), ethylene-ethylene/butylene-ethylene block copolymer (EEBE) and mixtures thereof. Preferred copolymers include hydrogenated styrene-butadiene-styrene block copolymer (SEBS), and hydrogenated styrene-isoprene-styrene block copolymer (SEPS).

The preferred thermoplastic elastomer copolymer is a styrene-isoprene-styrene block copolymer produced via anionic polymerization and available under the tradename VECTOR™ 4111 (Dexco Polymers; Houston, Tex.). This particular thermoplastic block copolymer is a linear, pure SIS triblock copolymer with a narrow molecular weight distribution, low styrene, low modulus copolymer. Namely, the copolymer has about 18 percent by weight styrene content, less than 1.0 percent by weight diblock content, and an MFR (200° C./5 kg) of about 12 g/10 min per ASTM D-1238.

VI. Compatibilizing Agent

A. General

Various compatibilizing agents can be employed to compatibilize the various constituents of the polymeric blends of this invention. Preferred compatibilizing agents include modified or functionalized polyolefins. These modified polyolefins are described in U.S. Pat. Nos. 6,001,484 and 6,072,003, which are incorporated herein by reference. Other useful agents include modified rubbers.

B. Modified Polyolefin

The term “modified polyolefin” means a random, block, or graft olefin copolymer having in a main or side chain thereof a functional group such as carboxylic acid; C₁ to C₈ carboxylate ester such as carbomethoxy, carboethoxy, carbopropoxy, carbobutoxy, carbopentoxy, carbohexoxy, carboheptoxy, carboctoxy, and isomeric forms thereof; carboxylic acid anhydride; carboxylate salts formed from the neutralization of carboxylic acid group(s) with metal ions from Groups I, II, III, IV-A and VII of the periodic table, illustratively including sodium, potassium, lithium, magnesium, calcium, iron, nickel, zinc, and aluminum, and mixtures thereof; amide; epoxy; hydroxy; amino; C₂ to C₆ acyloxy such as acetoxy, propionyloxy, butyryloxy; and the like; wherein said functional group is part of an unsaturated monomer precursor which is either copolymerized with an olefin monomer or grafted onto a polyolefin to form said modified polyolefin.

The modified polyolefin component defined above is represented by a large number of polyolefin random, block, and graft copolymers which have long been known in the art and, for the most part, are commercially available. Otherwise they are readily prepared using the conventional techniques for polymerizing olefin monomers; see Preparative Methods of Polymer Chemistry, W. R. Sorenson and T. W. Campbell, 1961, Interscience Publishers, New York, N.Y. Illustrative but non-limiting of the basic olefin monomers for copolymerization with the functional group containing unsaturated monomers are ethylene, propylene, butylene, mixtures of ethylene/propylene, mixtures of ethylene/butylene, mixtures of propylene/butylene, mixtures of ethylene/C₃ to C₁₂ α,β-unsaturated alkenes, and the like. Alternatively, the above illustrative monomers or mixtures are first polymerized to their corresponding polyolefins prior to grafting with said functional group containing monomers. A preferred class of modified polyolefin comprises a modified polyethylene, that is to say a polyethylene copolymer wherein the major molar proportion (at least 50 percent) of the copolymer consists of ethylene units copolymerized with at least one unsaturated monomer having a functional group substituent defined above, or a polyethylene (HDPE, LDPE or LLDPE) having grafted thereon a minor molar proportion (about 0.005 to 5 percent) of said at least one unsaturated monomer having the functional group substituent.

As illustrative embodiments of modified polyolefins in copolymer form are those derived from the copolymerization of any one of the olefin monomers set forth above but preferably ethylene in the minimum molar proportions of at least 50 percent with a vinyl functional group containing monomer such as acrylic acid, methacrylic acid, maleic acid, maleic anhydride, acrylamide, methacrylamide, glycidyl acrylate, glycidyl methacrylate, vinyl acetate, vinyl butyrate, methyl acrylate, ethyl acrylate, butyl acrylate, 2-hydroxyethyl acrylate, sodium acrylate, zinc acrylate, the ionic hydrocarbon polymers from the polymerization of α-oefins with α,β-ethylenically unsaturated carboxylic acids as described in U.S. Pat. No. 3,264,272 the disclosure of which is incorporated herein by reference, and the like. It will be understood that in the case of the olefin/vinyl acid copolymers that the carboxylic acid groups can be wholly or partially converted to metal salts (i.e., sodium, potassium, zinc) after formation of the copolymer. Such ionic copolymers are collectively recognized by the term “ionomers”. The vinyl functional monomers can be used in combination. Furthermore, mixtures of any of these modified polyolefins can be used.

As illustrative embodiments of modified polyolefins in grafted form are those derived from the graft polymerization of any one of the vinyl functional group containing monomers set forth above (preferably maleic anhydride) onto any one of the olefin polymers set forth above but preferably polyethylene (HDPE, LDPE, LLDPE). The proportions of said graft monomers are preferably within the molar range of 0.005 to 5 percent set forth above. As with the copolymers above, mixtures or combinations can be employed. Further, the vinyl functional group containing monomers can be grafted onto the modified polyolefin copolymers discussed above. A preferred embodiment of such a polymer type includes the product obtained by grafting maleic acid or anhydride onto an ethylene/vinyl carboxylate copolymer or the saponified copolymer derived from ethylene/vinyl acetate. The graft copolymerization of the unsaturated carboxylic acid or its functional derivative or another functional group-containing vinyl monomer onto the olefin polymer can be conducted using various methods. For example, the olefin polymer, the graft monomer and a free-radical initiator are incorporated in a solution or suspension of the olefin polymer in a suitable solvent. It is also possible to conduct the graft copolymerization in the presence of the thermoplastic polyurethane elastomer, i.e., after being blended with the thermoplastic polyurethane elastomer.

It will be understood by those skilled in the art that the modified polyolefins can be prepared using any combination of monomer reactants in either a copolymer, grafted copolymer, or copolymer-rafted copolymer configuration. However, a most preferred class of modified polyolefin comprises a copolymer or graft copolymer of ethylene or polyethylene (particularly LDPE or LLDPE) with at least one vinyl monomer having a functional group selected from carboxylic acid, carboxylate salts, dicarboxylic acid or anhydride thereof, carboxylate ester, and acyloxy, and mixtures of said modified polyolefins. Particularly, preferred species of modified polyethylene in this class are ethylene/vinyl acetate copolymer, ethylene/ethylacrylate copolymer, ethylene/methacrylic acid copolymer, ethylene/acrylic acid copolymer, ethylene/maleic anhydride graft copolymer, maleic anhydride grafted ethylene/vinyl acetate copolymer, and mixtures thereof in any combination and proportions.

Another group of modified polyolefins which can be used in terms of the present invention either alone or in combination with the modified polyolefins mentioned above are styrene/butadiene/styrene-block copolymer (SBS) and its hydrogenated form, i.e., SEBS block-copolymer grafted with the functional grafting group mentioned above.

Specific examples of said grafted modified polyolefin are polypropylene or ethylene propylene rubber grafted with anhydride, acid or primary or secondary amine, ethylene acrylic acid copolymers.

The modified polyolefin should contain from about 0.01 to about 10 percent by weight (pbw) of the functional moiety based upon the weight of the entire polymer. More preferably, the polyolefin should contain from about 0.05 to about 5 pbw of the functional moiety, even more preferably from about 0.75 to about 2 pbw of the functional moiety, and still more preferably from about 0.15 to about 1.0 pbw of the functional moiety based upon the weight of the entire polymer.

Useful modified polyolefins can be obtained under the tradename POLYBOND™ 3000 (Crompton).

C. Modified Rubbers

Modified rubbers include homopolymer or copolymer rubbers that contain terminal or pendant moieties containing acid or anhydride groups (e.g., carbonyl groups).

The terminal or pendent moieties typically derive from unsaturated carboxylic acids or unsaturated anhydrides. Examples of unsaturated carboxylic acids include citraconic acid, cinnamic acid, methacrylic acid, and itaconic acid. Examples of unsaturated anhydrides include maleic anhydride, citraconic anhydride, and itaconic anhydride. The preferred terminal or pendent moieties are succinic anhydride groups, or the corresponding acid from a ring opening structure, that derives from maleic anhydride.

The functionalized rubbers should contain from about 0.01 to about 10 percent by weight (pbw) of the functional moiety based upon the weight of the entire polymer. More preferably, the functionalized rubbers should contain from about 0.05 to about 5 pbw of the functional moiety, even more preferably from about 0.75 to about 2 pbw of the functional moiety, and still more preferably from about 0.15 to about 1.0 pbw of the functional moiety based upon the weight of the entire polymer.

The functionalized rubber additives are typically prepared by grafting unsaturated carboxylic acids or unsaturated anhydrides to a polyolefin polymer.

The techniques employed to attach the terminal or pendent moieties that contain carboxylic acid or anhydride groups to a polyolefin polymer are well known in the art. For example, grafting maleic anhydride to a polyolefin is disclosed in U.S. Pat. No. 6,046,279, which is incorporated herein by reference.

The rubber to which the unsaturated carboxylic acids and hydrides are attached can include a variety or rubbers. In one preferred embodiment, the rubber is an ethylene propylene rubber (EPR) or an elastomeric copolymer such as a terpolymer of ethylene, propylene, and a diene monomer (EPDM). EPDM rubbers are well known and are described in U.S. Pat. Nos. 6,433,090 and 6,437,030, which are incorporated herein by reference. Similar functionalized rubbers are disclosed in U.S. Pat. No. 6,169,145, which is incorporated herein by reference. Useful modified rubbers can be obtained under the tradename EXXELOR™ VA 1803 OR VA 1801 (ExxonMobil).

VII. Other Additives

Other additives that are typically employed in polymeric compositions can likewise be employed in practicing the present invention. These other additives can include pigments, UV stabilizers, biostats, fillers, oils, antioxidants, waxes, processing aids such as lubricants, and other similar ingredients.

VIII. Amounts

A. Thermoplastic Polyurethane

The polymeric blends of this invention will include from about 35 to about 80 percent by weight thermoplastic polyurethane, preferably from about 40 to about 75 percent by weight thermoplastic polyurethane, more preferably from about 45 to about 70 percent by weight thermoplastic polyurethane, even more preferably from about 50 to about 60 percent by weight thermoplastic polyurethane.

B. EVA

The polymeric blends of the present invention include from about 10 to about 250 parts by weight (pbw) ethylene vinyl acetate copolymer per 100 parts by weight thermoplastic polyurethane (phr), preferably from about 20 to about 200 pbw ethylene vinyl acetate copolymer phr, more preferably from about 30 to about 150 pbw ethylene vinyl acetate copolymer phr, and even more preferably from about 40 to about 100 pbw ethylene vinyl acetate copolymer phr.

C. Non-Polar Polymer

In certain embodiments of this invention, the polymeric blends include from about 10 to about 60 pbw non-polar polymer phr, preferably from about 20 to about 55 pbw non-polar polymer phr, more preferably from about 30 to about 50 pbw non-polar polyolefin phr, and even more preferably from about 40 to about 45 pbw non-polar polymer phr.

D. Softening Agents

In certain embodiments of this invention, the polymeric blends include from about 20 to about 100 pbw softening agent phr, preferably from about 30 to about 90 pbw softening agent phr, more preferably from about 40 to about 80 pbw softening agent phr, and even more preferably from about 50 to about 70 pbw softening agent phr.

E. Compatibilizing Agent

The polymeric blends of the present invention include from about 2 to about 30 pbw compatibilizing agent phr, preferably from about 5 to about 20 pbw compatibilizing agent phr, more preferably from about 7 to about 15 pbw compatibilizing agent phr, and even more preferably from about 9 to about 12 pbw compatibilizing agent phr.

IX. Preparation and Processing

The polymeric blends of this invention can be prepared by simply blending or mixing the polymeric ingredients together. Preferably, this blending takes place at an elevated temperature, such as a temperature from about 150° to about 200° C., or preferably from about 160° to about 195° C. In an especially preferred embodiment, the polymeric blends are prepared by mixing the ingredients within a twin screw extruder that employs a high shear screw at a temperature of about 180° to about 190° C.

X. Uses

The polymeric blends of this invention can be used in a variety of applications. In one particular use, the polymeric blends can be employed to make seals for use with containers that are fabricated from various polycarbonates and polycarbonate alloys such as polycarbonate/polyethyleneteraphthalate alloy. In another particular use, the polymeric blends of this invention can be used as an adhesive to secure polyester or nylon flock to various substrates including substrates made from EPDM or SANTOPRENE™. Advantageously, when the polymeric blends of this invention are employed as an adhesive in this regard, the use of volatile organic compounds as primers can be eliminated. In still another use, the polymeric blends of this invention can be employed as a laminating adhesive to secure various layers of polar and non-polar materials. In one example, the polymeric blends of this invention can be used to secure layers of polypropylene to polycarbonate or polycarbonate alloys. In another example, the polymeric blends of this invention can be used as an adhesive to secure layers of foamed polyethylene to layers of thermoplastic polyurethane elastomers.

XI. Specific Embodiments

In one preferred embodiment, where the polymeric blends of this invention are employed to make seals for containers fabricated from polycarbonate or polycarbonate alloys such as polycarbonate/polyethyleneteraphthalate alloys, an especially preferred formulation includes a thermoplastic polyurethane elastomer, ethylene vinyl acetate copolymer, maleated polypropylene, polypropylene homopolymer, and SANTOPRENE™. In one particular instance, the preferred formulation will include from about 48 to about 52 percent by weight thermoplastic polyurethane elastomer, from about 18 to about 22 percent by weight ethylene vinyl acetate copolymer, from about 13 to about 17 percent by weight SANTOPRENE™, from about 8 to about 12 percent polypropylene homopolymer, and from about 3 to about 7 percent maleated polypropylene. In another particular instance, the particular formulation will include from about 58 to about 62 percent by weight thermoplastic polyurethane elastomer, from about 13 to about 17 percent by weight ethylene vinyl acetate copolymer, from about 13 to about 17 percent by weight SANTOPRENE™, from about 3 to about 7 percent polypropylene homopolymer, and from about 3 to about 7 percent maleated polypropylene. Advantageously, when container seals are fabricated from these polymeric blends, the seal can withstand at least 4 minutes within a microwave, running at high power, and covering a bowl that includes a moist product such as tomato sauce. Also, these seals will advantageously remain adhered to a polycarbonate or polycarbonate alloy while withstanding an excess of 1,000 dishwasher cycles.

In order to demonstrate the practice of the present invention, the following examples have been prepared and tested. The examples should not, however, be viewed as limiting the scope of the invention. The claims will serve to define the invention.

### EXAMPLES

### Example 1

TABLE I

| | Example | | |
|---|---|---|---|
| | 1 | 2 | 3 |
| Formulation, phr | | | |
| Vistaflex 671N | 100.00 | — | 50.00 |
| Thermoplastic Polyurethane | — | 100.00 | 50.00 |
| Copolymers | | | |
| Total | 100.00 | 100.00 | 100.00 |
| Physical Properties, Unaged | | | |
| Shore A Hardness | 61 | 75 | 68 |
| 50% Modulus (psi) | 229 | 509 | 343 |
| 100% Modulus (psi) | 265 | 623 | 415 |
| Tensile Strength (psi) | 2,050 | 3,053 | 1,475 |
| Ultimate Elongation (%) | 850 | 801 | 650 |
| Toughness (psi) (in/in) | 5,081 | 11,030 | 4,740 |
| Shrinkage after 2 hrs @ 70° C. (%) | 5.71 | −1.35 | 1.41 |
| Shrinkage after 2 hrs @ 100° C. (%) | 12.68 | 4.25 | 2.86 |

The Vistaflex 671N was obtained from Advanced Elastomer Systems (Akron, Ohio), and this product includes about 43 percent by weight ethylene vinyl acetate copolymer (vinyl acetate content of 29% and a melt index of 29), about 43 percent by weight EPDM, and about 14 percent by weight white oil. The thermoplastic polyurethane elastomer was obtained under the tradename PELLETHANE™ 2103-80 PF (Dow chemical; Midland, Mich.).

TABLE II

| | Example | | |
|---|---|---|---|
| | 1 | 2 | 3 |
| Formulation (phr) | | | |
| Thermoplastic Polyurethane | 50.00 | 35.00 | 20.00 |
| Copolymer | | | |
| Ethylene Vinyl Acetate Copolymer | 45.00 | 60.00 | 75.00 |
| Maleic Anhydride Modified | 5.00 | 5.00 | 5.00 |
| Polypropylene | | | |
| Total | 100.00 | 100.00 | 100.00 |
| Physical Properties, Unaged | | | |
| Shore A Hardness | 80 | 81 | 80 |
| 50% Modulus (psi) | 555 | 531 | 517 |
| 100% Modulus (psi) | 668 | 635 | 614 |
| Tensile Strength (psi) | 1,575 | 2,433 | 2,611 |
| Ultimate Elongation (%) | 582 | 706 | 610 |
| Toughness (psi) (in/in) | 5,544 | 9,151 | 6,677 |
| Tension Set (%) | 18.5 | 21.0 | 23.5 |
| Bond Strength to Polycarbonate | 16.5 | 5.9 | 4.9 |
| Bond Strength to Polycarbonate | — | 13.6 | 10.4 |
| (430/400) | | | |
| Bond Strength to Untreated Polyester | 22.9 | 17.0 | 17.4 |
| Fabric | | | |
| Weight Gain in MeOH 1 week at | | 12.27 | 8.60 |
| RT (%) | | | |

The thermoplastic polyurethane elastomer was obtained under the tradename PELLETHANE™ 2103-80PF, the ethylene vinyl acetate copolymer was obtained under the tradename LD460.36, and the maleated polypropylene was obtained under the tradename Polybond™ 3000.

Various modifications and alterations that do not depart from the scope and spirit of this invention will become apparent to those skilled in the art. This invention is not to be duly limited to the illustrative embodiments set forth herein.

What is claimed is:

1. A polymeric blend comprising:
at least about 40 percent by weight thermoplastic polyurethane elastomer; and
from about 10 to about 250 parts by weight ethylene vinyl acetate copolymer per 100 parts by weight thermoplastic polyurethane elastomer.

2. A polymeric blend comprising:
at least about 40 percent by weight thermoplastic polyurethane elastomer;
from about 10 to about 250 parts by weight ethylene vinyl acetate copolymer per 100 parts by weight thermoplastic polyurethane elastomer; and
from about 10 to about 60 parts by weight polypropylene per 100 parts by weight thermoplastic polyurethane elastomer.

3. A polymeric blend comprising:
from about 48 to about 52 percent by weight thermoplastic polyurethane elastomer;
from about 18 to about 22 percent by weight ethylene vinyl acetate copolymer;
from about 13 to about 17 percent by weight thermoplastic vulcanizate comprising a blend of polypropylene and EPDM;
from about 8 to about 12 percent polypropylene homopolymer; and
from about 3 to about 7 percent maleated polypropylene.

4. A polymeric blend comprising:
from about 58 to about 62 percent by weight thermoplastic polyurethane elastomer;
from about 13 to about 17 percent by weight ethylene vinyl acetate copolymer;
from about 13 to about 17 percent by weight thermoplastic vulcanizate comprising a blend of polypropylene and EPDM;
from about 3 to about 7 percent polypropylene homopolymer; and
from about 3 to about 7 percent maleated polypropylene.
